(19) United States
(12) Patent Application Publication
(10) Pub. No.: US 2026/0301181 A1
(43) Pub. Date: Oct. 1, 2026

(54) AI-BASED METHOD AND SYSTEM FOR DETECTION OF CIRCULATING TUMOR CELLS IN BLOOD

(71) Applicant: VisionGate, Inc., Woodinville, WA (US)

(72) Inventors: Michael G. Meyer, Phoenix, AZ (US); Alan Nelson, Woodinville, WA (US)

(21) Appl. No.: 19/632,016

(22) Filed: Mar. 27, 2026

Related U.S. Application Data
(60) Provisional application No. 63/780,003, filed on Mar. 28, 2025.

(51) Int. Cl. G06T 7/00; G06T 7/60; G06T 12/20; G06T 12/30; G06V 10/764; G06V 20/64; G06V 20/69; G06V 10/82

(52) U.S. Cl. CPC G06T 7/0014; G06T 7/60; G06T 12/20; G06T 12/30; G06V 10/764; G06V 20/64; G06V 20/698; G06T 2207/10101; G06T 2207/20084; G06T 2207/30061; G06T 2207/30068; G06T 2207/30096; G06T 2207/30196; G06T 2207/30242; G06T 2210/41; G06T 2211/441; G06T 2211/456; G06V 10/82; G06V 2201/03

(57) ABSTRACT

The present disclosure provides an artificial intelligence (AI)-based circulating tumor cells (CTC) detection method using blood is disclosed. The method includes: generating, by an optical tomography system, a 2D image of a cell from a blood sample comprising a plurality of blood cells; evaluating the 2D image using 2D AI-based classification to determine if the cell is an CTC; generating, by the optical tomography system, a 3D image of the cell if the cell is determined to be an CTC; and evaluating the 3D image using 3D AI-based classification to determine if the cell is an CTC. In some embodiments, the cancer may be breast cancer or lung cancer. The present disclosure further provides optical coherence tomography systems able to perform such methods.

### TECHNICAL FIELD

The present disclosure relates to an AI-based system and method for classification of cells in blood to detect circulating tumor cells (CTCs), which may be indicative of high risk of metastatic cancer, or other abnormal cells indicative of high risk of cancer. More specifically, the system and method may be for classification of nucleated cells that result from a metastatic process, which may be CTCs that lack epithelial cell adhesion molecule (EpCAM) and/or cells that express EpCAM in whole blood from a patient previously diagnosed with cancer, especially breast cancer.

### BACKGROUND

Cancer remains a major cause of death and has serious adverse health and quality-of-life effects even in survivors. The probability of both death and adverse effects are lower with early detection for almost every known type of cancer. However, most reliable current detection methods remain unable to detect cancers until they have progressed to the point where diagnostic imaging of a physical exam or biopsy can locate the cancer. Earlier detection of cancer, or even a high likelihood of cancer, can substantially improve patient outcomes.

For example, breast cancer is the most common cancer in women. Over 250,000 new cases of invasive breast cancer being diagnosed in the US per year and over 40,000 breast cancer-related deaths occur. As of 2020, the breast cancer 5-year survival rate for those with non-metastatic breast cancer was 99%, but for metastatic breast cancer the 5-year survival rate declined to 27%. Early detection of metastatic breast cancer, particularly without the need for complex scans, will allow more effective treatment before metastases are as extensive, and is expected to improve survival significantly. The need for a non-invasive diagnostic test to monitor for metastatic breast cancer risk with high sensitivity and specificity is still a high priority.

### BRIEF SUMMARY

The present disclosure provides an artificial intelligence (AI)-based circulating tumor cell (CTC) detection method using blood comprising: a) generating, by an optical tomography system, a 2D image of a cell from a blood sample comprising a plurality of blood cells; b) evaluating the 2D image using 2D AI-based classification to determine if the cell is an CTC; c) generating, by the optical tomography system, a 3D image of the cell if the cell is determined to be an CTC; and d) evaluating the 3D image using 3D AI-based classification to determine if the cell is an CTC.

The disclosure further provides the following additional aspects of the above method, which may be combined with one another in any fashion:

a 3D image of the cell is not generated if the cell is determined by 2D AI-based classification to not be a CTC;

the method further comprises e) repeating a) to d) for a subset of cells within the plurality of cells to generate blood sample data that includes a total cell count reflecting the total number of cells evaluated using 2D AI-based classification and a CTC count reflecting the total number of cells determined to be an CTC by 3D AI-based classification;

the method further comprises: f) comparing the total cell count to a cell count threshold number and repeating steps a) to e) if the total cell count is lower than the cell count threshold number;

the cell count threshold number is sufficient to ensure a pre-selected accuracy of classification of CTCs;

the threshold number is between 900 and 1100;

the method has a pre-selected 2D AI-based classification sensitivity value for CTCs of at least 90%;

the method has a pre-selected 2D AI-based classification specificity value for CTCs of at least 65%;

the method has a pre-selected 3D AI-based classification sensitivity value for CTCs of at least 90%;

the method has a pre-selected 3D AI-based classification specificity value for CTCs of at least 65%;

the CTC count is compared to a CTC threshold and the sample is classified as from a patient with metastatic breast cancer if the CTC count is at or above the CTC threshold;

the CTC count is compared to a first CTC threshold and a second CTC threshold and the sample is classified as from a patient with high risk of metastatic breast cancer if the CTC count is at or above the first CTC threshold and below the second CTC threshold, and further where the sample is classified as from a patient with metastatic breast cancer if the CTC count is at or above the second CTC threshold;

the CTC count is a positivity rate calculated using a total number of CTCs classified compared to a total cell count;

the blood sample comprises CTCs, epithelial cells, endothelial cells, white blood cells, debris, cell clusters, and any combinations thereof;

the method further comprises, prior to a), pre-processing the blood sample to stain the plurality of cells with an agent that facilitates generating the 2D image, evaluating the 2D image using 2D AI-based classification, generating the 3D image, or evaluating the 3D image using 3D AI-based classification;

the method further comprises, prior to a), i) embedding the blood sample in an optical medium and injecting the optical medium with embedded sample into a capillary tube; and ii) loading the capillary tube into the optical tomography system so that the capillary tube is between an illumination source and objective lens of the optical tomography system;

generating, by the optical tomography system, the 2D image of the cell comprises the optical tomography system sweeping a focal plane of the optical tomography system in 1 µm steps across a single cell to generate a single-plane 2D image of the single cell at each step, compiling a plurality of single-plane 2D images of the single cell, and filtering the set of single-plane 2D images of the single cell to generate the representative 2D image of the cell evaluated in b);

the representative 2D image of the cell is an image of a central portion of the cell;

evaluating the 2D image using 2D AI-based classification comprises determining values for a plurality of 2D image cell feature measurements;

the cell feature measurements comprise object shape features, cell-shape features, cytoplasm features, cell nucleoli features, distribution of chromatin, nuclear-size features, nuclear-texture features, other morphometric elements, or any combination thereof;

evaluating the 3D image using 3D AI-based classification comprises determining values for a plurality of 3D image cell feature measurements;

the cell feature measurements comprise object shape features, cell-shape features, cytoplasm features, cell nucleoli features, distribution of chromatin, nuclear-size features, nuclear-texture features, other morphometric elements, or any combination thereof;

the method further comprises determining if the cell is a white blood cell, a type or subtype of white blood cell, or a white blood cell having a specific phenotype.

The disclosure further provides a cell classification system comprising an optical tomography system operable to: generate a 2D image of a cell from a blood sample comprising a plurality of blood cells; evaluate the 2D image using 2D AI-based classification to determine if the cell is an CTC; generate, a 3D image of the cell if the cell is determined to be a CTC; and evaluate the 3D image using 3D AI-based classification to determine if the cell is a CTC.

The disclosure further provides a cell classification system comprising an optical tomography system operable to perform any of the above methods.

### DESCRIPTION OF THE DRAWINGS

The patent or application file contains at least one drawing executed in color. Copies of this patent or patent application publication with color drawing(s) will be provided by the Office upon request and payment of the necessary fee.

The disclosure may be better understood through reference to the following detailed description in conjunction with the drawings, which are provided as examples only, in which like elements are indicated by letters (e.g., 40a, 40b, 40c), and in which:

FIG. 1 is a schematic representation of an optical tomography system that may be used in the present disclosure;

FIG. 2 is a schematic representation of the optical tomography system as operated to acquire a plurality of 2D images of a blood cell that may be used in the present disclosure;

FIG. 3 is a logical diagram of a method for classification of cells in blood that may be used in the present disclosure.

FIG. 4 is a representation of a plot that might result from evaluation of an AI-based algorithm during training of that algorithm.

FIG. 5 is set of two representative 2D images of different perspectives of a 3D image of a breast cancer CTC generated using a Cell-CT system, as well as images of granulocytes, lymphocytes, and monocytes generated using a Cell-CT system.

FIG. 6 is a ROC diagram generated in a test assay using lysed whole blood with BT474 breast cancer cells added.

### DETAILED DESCRIPTION

The present disclosure relates to a method and system for classification of nucleated cells in blood (e.g., not mature red blood cells (RBCs) or platelets, which lack a nucleus) that includes an AI-based classification method and system. The method and system may be used to detect CTCs among a plurality of cells from a blood sample. The blood sample may be obtained from a patient in a conventional manner and may be a whole blood sample. The blood sample may be processed to provide an enriched sample that has an increased proportion large nucleated cells.

The AI-based system and method may classify cells in the enriched sample simply as CTCs and non-CTCs, or as CTCs and additional specific types of cells, such as white blood cells (WBCs), and non-CTC/non-WBCs. In some embodiments, the AI-based system and method may further detect and classify other abnormal cells associated with metastatic breast cancer that are not CTCs, but that are identified using parameters determined by the AI-based system via a training process using enriched blood samples from patients having metastatic breast cancer, and patients not having metastatic breast cancer, including, in some examples, patients with non-metastatic breast cancer, with non-cancerous breast tissue abnormalities, such as benign tumors or fibrous deposits, or with other types of cancer or tumors.

Cells that express EpCAM are known to likely be CTCs, which are associated with a higher risk of metastasis. As a result, methods that detect cells expressing EpCAM (EpCAM+) cells, have been previously attempted to assess metastasis risk. However, cells that have undergone epithelial mesenchymal transition (EMT) are often the most aggressive CTSs and are more likely to become metastatic than EpCAM+ CTCs. These cells (EMT CTCS) do not express EpCAM (are EpCAM negative). Accordingly, the system and method may assess EpCAM- cells that are CTCs, and may additionally asses EpCAM+ cells.

The system and method may use a CTC count or CTC positive rate to determine if the patient has a high risk of metastatic breast cancer, is responding to treatment, or has minimum residual disease. The term “cancer” refers to a hyperproliferation of cells that results in unregulated growth, lack of differentiation, local tissue invasion, or metastasis. “Metastatic” cancer occurs when CTCs detach from the primary site and travel in the blood stream. A higher number of CTCs is associated with increased risk of metastasis. Accordingly, the system and method may make the determination based on CTC counts above CTC count thresholds, which may be expressed as a positive rate in which CTC counts are compared to total cell counts, non-CTC counts, or non-CTC/non-hematocyte counts. Depending on the determination, the patient may be treated for metastatic cancer or referred for further diagnostic testing.

Treatment for metastatic cancer is frequently different than treatment for non-metastatic cancer for a number of reasons. For example treatment may differ due to differences in expected biological responses to treatment. As another example there may be differences in treatment location, which can often be focused on the primary cancer in non-metastatic cancer. As yet another example, treatment may be selected based on differences in the acceptable risk of harm to the patient by the treatment itself. Potential harm to the patient by the treatment may be more acceptable when balanced against the increased risk of severe health consequences or death when metastatic cancer is present, as opposed to lower risks posed by non-metastatic cancer.

Further diagnostic testing when metastatic cancer is not detected using systems and methods of the present disclosure may also be different than diagnostic testing that would otherwise be conducted. For example, a negative result for metastatic cancer may be accepted as conclusive that the patient has non-metastatic cancer. In such cases, further diagnostic testing for metastatic cancer may not be needed, whereas, absent the results obtained using the systems and methods of the present disclosure, other diagnostic testing for metastatic cancer might be advised. In another example, the timing of diagnostic testing might vary. Although, ideally, cancer diagnostics would be conducted right away whenever a cancer is detected or suspected, that is not always possible, particularly when the patient’s own health makes diagnostic testing difficult. The ability to defer testing until the patient is better health based upon results of a simple blood sample might spare the patent diagnostic-based health risks. In yet another example, the frequency of repeated diagnostic tests, including repeated diagnosis using the systems and methods of the present disclosure, may occur with greater intervals between tests if the cancer is likely non-malignant. All of these changes in further diagnostic tests may spare the patient unnecessary testing.

The present application focuses on metastatic breast cancer (such as ductal carcinoma) as a model that has been verified through analysis of results obtained using a trained system and method of the present disclosure. Data obtained using metastatic breast cancer may be found in the Examples below. The system and method may be further verified by test results obtained with lung cancer (particularly adenocarcinoma), which also frequently results in CTCs in the blood. In some such tests, A549 cells (a human lung adenocarcinoma cell line) may be were deliberately added to human blood samples to determine if the cells could be accurately detected, using methods similar to those in the Examples below. Given the verification of the systems and methods of the present disclosure using breast cancer cells and the potential for verification using lung cancer models, and the similarity of metastatic cancer cells among numerous types of cancer (including cancers in which the primary cancers are much more distinct from one another) it is expected that other metastatic cancers that result in CTCs in the blood may also be diagnosed using these systems and methods.

Threshold cell counts referenced herein, other than in the context of the number of cells required to be processed to ensure accuracy of the assay, may refer to total number of the referenced type of cell(s) or a positive rate derived from the total number of the referenced type of cell(s) and the total number of another type of cell(s).

In some embodiments, residual RBCs or platelets may not be included in any cell counts used to determine CTC positivity rates, as these cells are not nucleated and clearly are not CTCs. However, WBC, RBC, platelet, or total hematocyte counts may be used to determine if sample enrichment was successful. The presence of a high proportion or number of any hematocytes may indicate failure of the enrichment process.

The system and method may use various tools not available in traditional pathology methods, such as AI-based classifications, enhanced images, image analysis tools, 2D images, 3D images, and image storage and comparisons.

In some embodiments, the optical tomography system may be a CELL-CT^{®} system (VisionGate, Inc., Washington, USA).

### Optical Tomography System

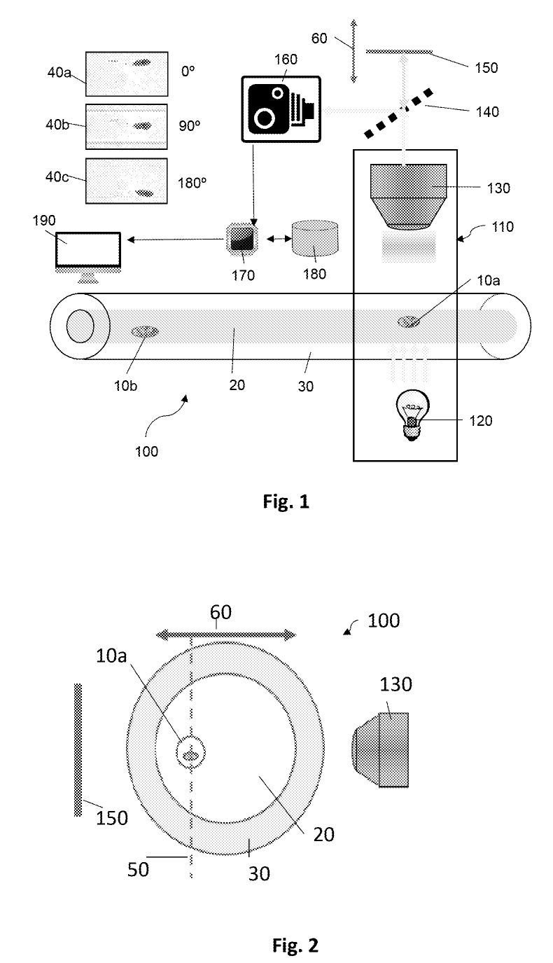

Referring now to FIGS. 1 and 2, an AI-based system of the present disclosure may include, or an AI-based method of the present disclosure may be carried out using optical tomography system 100, which may be used to produce both 3D images and 2D images of a blood cell 10 (such as cell 10a or cell 10b). As used herein, a “blood cell” merely refers to a cell found in a blood sample. A “blood cell” need not be a cell type formed via hematopoiesis, such as a red blood cell, white blood cell, or platelet and, in most embodiments, blood cells formed via hematopoiesis will be excluded from or greatly reduced in number in the enriched blood sample. Although the operation of the optical tomography system is described for acquiring images of one cell 10, in a volume of optical medium in the optical path of a high-magnification microscope, images of multiple cells 10 within the same volume of optical medium may be acquired. Furthermore, images sufficient to classify debris or clusters as such may also be acquired.

The optical tomography system 100 may include a cell imaging system 110, which includes an illumination source 120 optically coupled to an objective lens 130, such that illumination passes through the micro-capillary tube 30 and any intervening cell 10 before reaching the objective lens 130. The illumination then passes through the objective lens 130 to a beam-splitter 140, which causes part of the illumination to be deflected to a mirror 150 and reflected back to the beam-splitter 140 before being transmitted to a high-speed camera 160, and another part of the illumination to be transmitted directly through the beam-splitter 140 to the high-speed camera 160, to generate pseudo-projection images 40 of the cell 10 contained in an optical medium 20 in a micro-capillary tube 30. During 3D imaging, at least one pseudo-projection image 40 of the cell 10 is generated by scanning the volume occupied by the cell 10 by vibrating the mirror 150 in direction 60 (typically using an actuator, such as a piezo-electric motor, not shown), thus sweeping the plane of focus 50 through the cell 10 and then integrating the image to create the pseudo-projection image from a single perspective. Additional pseudo-projection images are obtained by rotating the micro-capillary tube 30. The pseudo-projection images are each a single image that represents a sampled volume that has an extent greater than the depth of field of the objective lens 130. The high-speed camera 160 generates, for each cell 10, a plurality of pseudo-projection images 40 that correspond to a plurality of axial micro-capillary tube rotation positions, examples of which are illustrated as 40a, 40b, and 40c in FIG. 1. In some embodiments, 500 pseudo-projection images are generated as the micro-capillary tube 30 is rotated through 360°.

In some embodiments, optical tomography system 100 is communicatively coupled to a processor 170 operable to receive the plurality of pseudo-projection images 40 from the high-speed camera 160 and use the pseudo-projection images 40 to generate a 3D image (not shown) of the cell 10.

Images before or after manipulation by the processor 170 may be stored in communicatively coupled memory 180. The processor 170 may send data regarding the cell 10, or data relating to or derived from a plurality of cells 10 contained in a blood sample to a communicatively coupled output 190. Data sent to the output 190 may include 2D or 3D images of one or more cells 10, or a summary of cells in a blood sample analyzed by the optical tomography system 100. A summary may, in some embodiments, include a graph, a table, or an index, such as an abnormality index, reflecting the likelihood that the patient has or is at high risk for developing metastatic breast cancer, or even a simple indication that the sample is positive for cells indicative of metastatic breast cancer.

In embodiments disclosed herein, the optical tomography system 100 may also be operated to generate a representative 2D image of the cell 10. In such embodiments, the objective lens 130 has a focal plane 50 that moves as the objective lens 130 sweeps across the micro-capillary tube 30 and any cell 10 in a back-and-forth direction 60 to produce a plurality of 2D images (not shown). This method of generating 2D images by moving the objective lens 130 is different than the method of producing 3D images using pseudo-projection images that are generated by vibrating the mirror 150. The processor 170 is operable to receive the plurality of 2D images and determine a representative 2D image of the cell 10.

In some embodiments, the representative 2D image of the cell 10 is an image of the central portion, such as the center, of the cell. The processor 170 is then further operable to perform AI-based classifications of the representative 2D image using 2D cell classifiers as described herein to determine if the cell 10 has abnormal features, and is, therefore, more likely than cells without abnormal features to be a CTC or other cell indicative of metastatic breast cancer, or if the cell 10 does not have abnormal features and is, therefore an other cell or as a non-excluded cell. In some embodiments, the 2D cell classifiers may be used in AI-based classifications to further identify abnormal cells that are not CTCs. Such abnormal cells that are not CTCs may be excluded, used for other data (such as data indicating that the blood sample is sufficient and has been processed appropriately, or that false positives and false negatives are within accepted parameters), or used as a further indicator of metastatic breast cancer. In some embodiments, after generating 3D images for a pre-selected number of other cells, 3D images may thereafter only be generated for cells determined to likely be CTCs and/or other abnormal cells via AI-based classification of 2D images.

A substantial number of cells 10 even in an enriched blood sample are not likely to be indicative of metastatic breast cancer, such that producing 3D images of these cells is not useful in detecting metastatic breast cancer. Many of these cells may have the morphology of a non-nucleated blood cell, such as an RBC or platelet, and may be excluded on that basis, speeding sample processing time. Red blood cells and platelets, in particular may be excluded. Given the role immune function plays in controlling cancer, in some embodiments, certain types of white blood cells or white blood cells with certain morphologies may be determined by the trained AI-based system to correlate with metastatic breast cancer, and, in those embodiments, may be subject to 3D imaging.

In some embodiments, the cell imaging system 110 includes the illumination source 120, the objective lens 130, the beam-splitter 140, mirror 150, and the high-speed camera 160.

In some embodiments, the optical tomography system 100 further includes the processor 170, any communicatively coupled memory 180, and the communicatively coupled output 190.

In certain embodiments, the optical tomography system 100 further includes the micro-capillary tube 30, the optical medium 20, or one or more cells 10, but in other embodiments, the optical tomography system 100 does not include one or more of these potential components, although they may be supplied for operation of the system.

In certain embodiments, the AI-based cell classification system 100 is operable to generate images in at least two distinct modes. One mode includes a cell search mode, during which 2D images of a cell 10 are generated and processed to generate a representative 2D image, which is then used to determine whether the cell 10 is a CTC or otherwise has abnormal features. 2D images in this mode are generated by moving the objective lens 130 in direction 60 to sweep the focal plane 50 through the cell. A second mode includes a projection image capture mode, during which pseudo-projection images 40 are generated and used to produce a 3D image of the cell 10 if the cell 10 has been determined to be a CTC or have abnormal features during the cell search mode. 3D images in this mode are generated by vibrating the mirror 150 in direction 60 to create the pseudo-projection images 40.

### Blood Cell Detection Methods

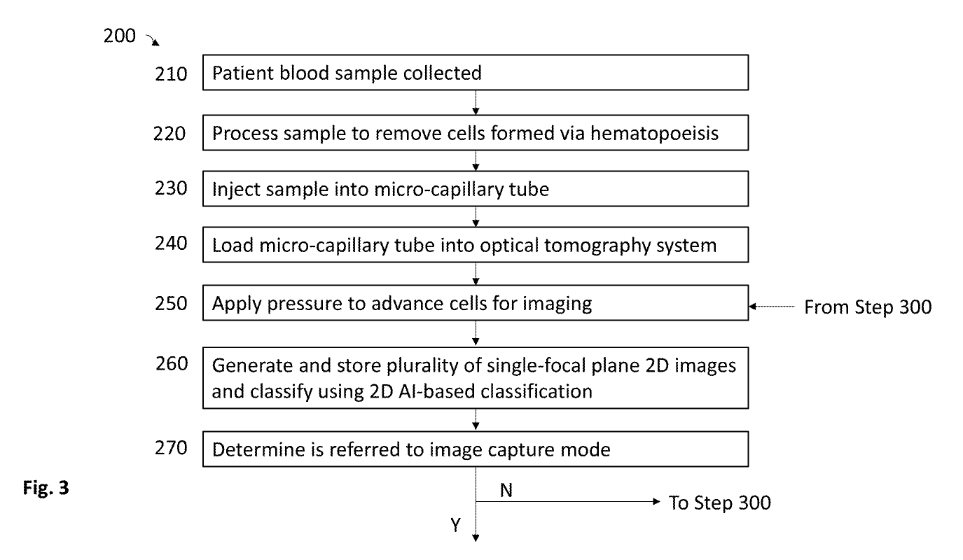

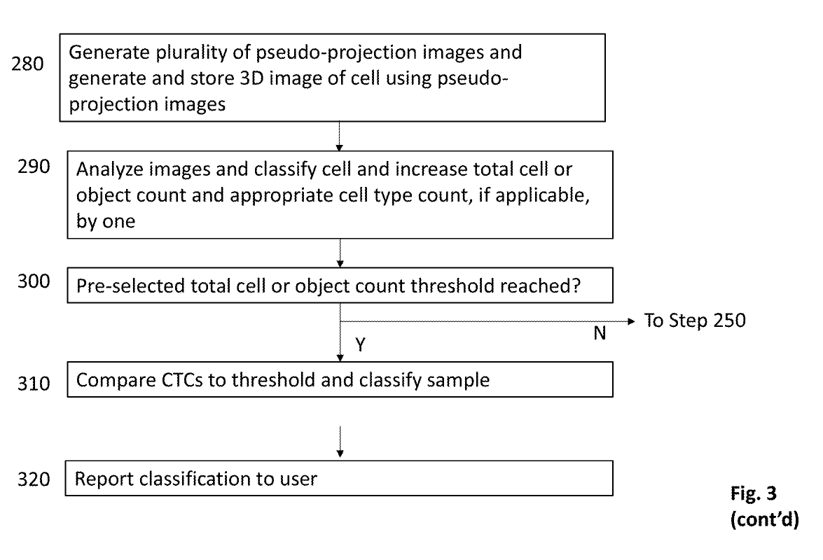

FIG. 3 describes a blood cell detection method 200, which may be performed using an optical tomography system, such as the optical tomography system 100. Elements of the optical tomography system 100 are referenced in this description of the blood cell detection method 200 as examples. Similar components of different optical tomography systems may also be used in connection with the blood cell detection method 200.

The blood cell detection method 200 includes a step 210 in which a blood sample is collected from a patient. The sample may be collected via any conventional manner used for blood samples intended to cytological analysis. The blood sample may be stored under any conditions that avoid cells being degraded to the point where limited cellular content remains at the time of optical tomographic analysis. For example, the blood sample may be refrigerated. In some embodiments, the blood sample may be stored for up to 6 hours, 12 hours, 24 hours, or 48 hours after collection before optical tomographic analysis. Storage time and conditions, such as use of refrigeration or storage at room temperature, may be noted, particularly when debris or cluster counts are obtained, as these conditions may affect cell death and resulting debris or cellular aggregation and may, therefore, be relevant to any diagnoses based on these counts.

In some embodiments, the blood sample may contain cells not formed via hematopoiesis, such as ductal breast cancer cells, which may have abnormal features and a nucleus. Some such abnormal cells may have additional features that identify the cells as CTCs. Some such abnormal cells may also have additional features that identify the cells as EpCAM- CTCs. Other cells found within the sample may include epithelial cells, endothelial cells, white blood cells, red blood cells, platelets, debris, clusters, and low numbers of other cells.

In step 220 the blood sample is processed for analysis. Whole blood from a patient with metastatic breast cancer contains approximately 1 CTCs per 10⁹ RBCs, so processing to reduce the RBC count without eliminating CTCs may be particularly useful, For example, the blood sample may be centrifuged to concentrate the plurality of cells 10 prior to placement in optical medium 20. In some embodiments, the blood sample may be centrifuged to separate a red blood cell fraction, a while blood cell fraction, and a plasma fraction. Only the fraction(s) likely to contain CTCs and nucleated cells may be used for further analysis. In another example, RBCs in the sample may be lysed using any lysis process, particularly processes already developed for clinical or laboratory use. In lysed blood, there are approximately 1 CTCs per 10⁶ WBCs (the major cell type present after RBC lysis). Thus, although lysis still leave a substantial number of cells to be processed in order to identify CTCs, the number of cells is still several orders of magnitude lower than if RBCs are not lysed.

Processing may optionally include staining to render any of the plurality of cells 10 or any features, such as the nucleus of any of the plurality of cells 10, easier to detect using the optical tomography system 100, or otherwise staining or treating the cells with an agent that facilitates generating the plurality of 2D images of the cell 10, evaluating any of the plurality of 2D images, generating a 3D image of the cell 10, or analyzing the 3D image. In specific embodiments, the plurality of cells 10 may be stained with a chromatin stain, such as a hematoxylin or bluing reagent. In other specific embodiments, the plurality of cells 10 may be stained with a cytoplasm stain, such as eosin. Bluing reagents may also render the nuclear membrane more readily detectable. In some embodiments, only a hematoxylin or bluing reagent is used. In some embodiments, the plurality of cells 10 are stained with two or all three of a hematoxylin, a bluing reagent, and eosin.

In still other embodiments, other staining agents, such as 4′,6-diamidino-2-phenylindole (DAPI) (which tends to stain debris) and/or cytoskeleton protein-staining agents, may be used in conjunction with FACS-based enrichment. In some embodiments, FACS-based enrichment may be used to specifically identify and retain cells that are likely to be CTCs. In other embodiments, FACS-based enrichment may be used to specifically identify and remove cells that are not CTCs, such as cells formed via hematopoiesis, simply leaving other cells types, which are likely to include CTCs, in the fraction not removed. FACs may be used in connection with other enrichment processes, such as prior removal of red blood cells via centrifugation.

The plurality of cells 10 may be treated to ameliorate aggregation. Suitable treatments may include washing the cells, for example in phosphate buffered saline (PBS) prior to staining, washing the cells in distilled water (dH₂O) prior to any ethanol dehydration, or resuspending an ethanol dehydrated cell pellet in xylene. Treatments to ameliorate aggregations may be avoided if cluster count is detected in the overall method and used for any clinical determinations.

Following any optional staining or ameliorations of aggregation, the sample processing 220 includes placing the cells 10 contained in the sample in an optical medium 20.

The optical medium 20 may be any medium reasonably expected to maintain the cells 10 intact during the expected duration of time prior to and during optical tomography. The optical medium 20 may also have a viscosity that allows movement of the optical medium 20 through a micro-capillary tube 30. The optical medium 20 may also not interfere with image generation by the optical tomography system 100. In particular, the optical medium may have an optical index that matches the optical index of other components of the optical tomography system 100 and the micro-capillary tube 30 through which light passes during image acquisition. Typically the optical tomography system 100 components through which light passes and the micro-capillary tube 30 also have a matching index. For optimal optical tomography operation, any changes in light movement should be due to encountering the object to be imaged, not changes in the optical index of other components or objects in the light path.

In the step 230, the optical medium 20 containing a plurality of cells 10 from the blood sample is injected into a micro-capillary tube 30. In some embodiments, the micro-capillary tube 30 may have an outer diameter of 500 µm or less, for example, between 30 µm and 500 µm. In some embodiments, the micro-capillary tube 30 may have an inner diameter of 400 µm or less, for example, between 30 µm and 400 µM, such as 50 µm. In one embodiment, the entire portion of the blood sample to be analyzed is placed in one micro-capillary tube 30. In another embodiment, the portion of the blood sample to be analyzed is placed in a plurality of micro-capillary tubes 30, which may be evaluated sequentially. In still another embodiment, the sample may be pumped through the micro-capillary tube 30 from a sample reservoir.

In the step 240, the micro-capillary tube 30 is loaded into the optical tomography system 100 so that the micro-capillary tube 30 is between the illumination source 120, and the objective lens 130.

In step 250, the optical medium 20 and any cells 10 contained within it are advanced into (prior to the initial step 240) or through the micro-capillary tube 30 by applying pressure at one end of the micro-capillary tube, such that a different volume of the optical medium 20 carrying a different portion of the blood sample is in the optical path of the optical tomography system 100, between the illumination source 120 and the objective lens 130. In some embodiments, a plunger (not shown) is used to advance the optical medium 20. For instance a plunger may be applied to a reservoir (not shown) of the optical medium 20 and blood sample that is connected to the micro-capillary tube 30, forcing additional optical medium 20 from the reservoir into the micro-capillary tube 30.

Next, in step 260, the optical tomography system generates and stores a plurality of single-focal plane 2D images of the cell 10 in cell search mode. In some embodiments, in the cell search mode, the optical tomography system 100 sweeps the focal plane 50 through the cell 10 in the direction 60 at 1 µm intervals to capture a series of 2D images. To determine the location of and preserve the image of at least one cell 10, at least a portion of the series of single-focal plane 2D images are compiled and filtered by the processor 170 to determine if the 2D images contains features associated with a cell 10 or other solid object in the optical medium 20, such as being dark as compared to the optical medium 20. Multiple cells 10 may be identified in the same volume of optical medium 20 in the optical path of the optical tomography system 100.

In some embodiments, 2D AI-based classification may be employed to analyze the plurality of 2D images of the cell 10. The AI-based classification method may determine if the cell 10 is a CTC, other abnormal cell of interest, epithelial, endothelial, white blood cell, red blood cell, platelet, a cluster, or debris.

In step 270, the optical tomography system determines if the cell 10 is of a type to be referred to projection image capture mode. If the cell 10 is of such a type, the method proceeds to step 280. If the cell 10 is not of such a type and is excluded from image capture mode, the total cell count, and any other relevant count, is increased by one and the method moves to step 300.

In some embodiments, debris or clusters may be detected by 2D AI-based classification and excluded from projection image capture mode. If a debris or cluster count is maintained in the method, then the relevant count is increased by one and the blood cell detection method 200 moves on to step 300.

In some embodiments, any of abnormal cells not of interest, epithelial, endothelial, white blood cells, red blood cells, and platelets may be detected by 2D AI-based classification and excluded from projection image capture mode. The total cell count is increased by one and, if a count of any such cell type is maintained in the method, then the relevant count is also increased by one, and the blood cell detection method 200 moves on to step 300.

In some embodiments, normal cells or abnormal cells not of interest may be detected by 2D AI-based classification and excluded from projection image capture mode. The total cell count is increased by one and, if a normal cell count is maintained in the method for any normal cell type (typically a type expected to be found in a properly-process sample, or a type indicative of improper sample preparation, such as red blood cells), then that count is also increased by one, and the blood cell detection method 200 moves on to step 300.

In some embodiments, the sample may be rejected prior to complete analysis based on 2D AI-based classification. For example, red blood cells, debris, and clusters are all very readily distinguishable using 2D AI-based classification. If more than a threshold number of cells 10 are classified as red blood cells, debris, or cluster by 2D AI-based classification (or by 3D AI-based classification in methods that do to include any 2D classifications) then the blood cell detection method 200 may terminate by providing a message that the sample was rejected.

In some embodiments, only cells 10 identified as CTCs by 2D AI-based classification may proceed to projection image capture mode. In such embodiments, when a cell 10 is not identified using 2D AI-based classification as a CTC, then the total cell count is increased by one and the blood cell detection method 200 moves on to step 300.

In other embodiments, cells 10 identified as CTCs or otherwise abnormal by 2D AI-based classification may referred to projection image capture mode, while cells 10 identified as red blood cells white blood cells, platelets, other normal cells, debris, or clusters are excluded from projection image capture mode.

In some embodiments, a set number of cells 10 classified using the plurality of 2D images as excluded from projection image capture mode are, nevertheless, processed in projection image capture mode and, optionally, also classified using 3D AI-based classification to allow assessment of 2D AI-based classification accuracy or to provide representative images.

In step 280, the method generates a plurality of pseudo-projection images of the cell 10 in projection image capture mode and, also generates and stores a 3D image of the cell 10 using the pseudo-projection images. In projection image capture mode, the optical tomography system 100 generates a plurality of pseudo-projection images 40 by vibrating the mirror 150.

In step 280, the processor 170 uses at least a portion of the plurality of pseudo-projection images 40 to generate a 3D image of the cell 10. Typically, all pseudo-projection images 40 are used to generate the 3D image of the cell 10. However, if pseudo-projection images 40 that are determined to be of poor quality or likely to contain errors, the 3D imaging of the cell may be discontinued. In addition, typically pseudo-projection images 40 that cover 360 degrees of rotation around the cell 10 are used to generate the 3D image, but pseudo-projection images that cover as little as 180 degrees of rotation around the cell 10 may be used.

In step 290, the plurality of 3D images is used in combination with 3D AI-based classification to analyze the cell 10 and classify the cell 10 as a CTC if the cell 10 is such a cell. The cell 10 may also be classified as another abnormal cell of interest, epithelial, endothelial, white blood cell, red blood cell, platelet, or other normal cell. The cell 10 may also be identified as debris or a cluster rather than a single cell. After 3D AI-based classification as a cell, a total cell count is increased by one, if not already increased by one during 2D imaging, or, in instances where 3D imaging revels the object to be something other than a cell, any cell count from 2D imaging may be decreased by one. If the cell 10 is identified by 3D AI-based classification as a CTC, this count is increased by one. If the cell 10 is identified by 3D AI-based classification as CTC, another abnormal cell of interest, epithelial, endothelial, white blood cell, red blood cell, platelet, or other normal cell, the relevant count, if maintained, may be increased by one.

In both 2D and 3D AI-based classification, in which the processor 170 may detect and measure any of a plurality of cell features in the 2D or 3D images. In some embodiments, the processor 170 detects a nucleus portion and a non-nucleus cellular portion of the cell 10 and segments 2D or 3D images into nucleus and non-nucleus portions. In some embodiments, the processor 170 detects and analyzes boundaries of other structures within the cell. Cell features may be in certain categories, including whole-cell, nucleus, cytoplasm, or nucleoli features. Cell features may be of certain types, such as greyscale histogram (e.g. median, average, 2^{nd}-3^{rd} or -4^{th} statistical moment), spatial distribution (e.g. statistical movements of the Fourier transform), shape (e.g. eccentricity, deviation from spherical ideal), volume, or ratio features (e.g. ratio of nucleus to cytoplasm volume, deviation of the nucleus from cell centroid and center of mass). In some embodiments, the cell feature measurements may include object shape features, cell-shape features, cytoplasm features, cell nucleoli features, distribution of chromatin, nuclear-shape features, nuclear-size features, such as area of nuclear surface, nuclear-texture features, nuclear invaginations, other morphometric elements, such as ratio of nuclear to cytoplasm volume, average grapy value, spatial frequencies, grey moments, geometric moments, or any combination thereof.

In some embodiments, the features analyzed may be determined by a human. In other embodiments, AI-based classification may in addition or alternatively include analyzing features determined by AI (which may be the same or a different AI as that performing the AI-based classification), or by analyzing other image components, which may also be determined by AI. Features analyzed in this embodiment may be the same as or different from cell features pre-determined by a human as discussed above.

Classification of cells as CTCs or other cells having abnormal features may have a pre-selected AI-based classification accuracy, such as a pre-selected AI-based classification sensitivity or a pre-selected AI-based classification specificity. In some embodiments, classification of cells as epithelial, endothelial, white blood cell, red blood cell, platelet, or other normal cell, or classification as debris or a cluster may also have a pre-selected AI-based classification accuracy. Accuracy for objects other than CTCs may be particularly important where such object is used for diagnostic purposes, such as white blood cells, including specific white blood cell types or white blood cells having specific features, above a white blood cells threshold to diagnose infection or an immune response indicative of cancer or an inability to control cancer, or clusters above a cluster threshold to indicate a higher metastatic breast cancer risk in patients with CTCs counts near a threshold.

In some embodiments, the CTCs may include both EpCAM+ and EpCAM- CTCs. These CTCs may not be specifically identified with respect to their EpCAM status, as this may not be a feature assessed by the AI during classification. Accordingly, EMT CTCs will be included in the CTC count.

In some embodiments, particularly those in which a marker for EpCAM, such as an anti-EpCAM antibody, is applied to the sample prior to assessment, EpCAM+ CTCs and EpCAM- CTCs may be separately identified.

In addition to determining, based on CTCs, whether a patient has metastatic or non-metastatic cancer, systems and methods of the present disclosure may also determine other diagnostically relevant information from a blood sample. In particular, given the ability of the systems and methods of the present disclosure to accurately distinguish different cell types even among cells derived from the same tissue or cancer, it is expected that, not only can WBCs be identified, clinically significant additional information about WBC can also be determined. In some embodiments, these systems and methods may be able to distinguish among different types of WBCs. In one embodiment, the systems and methods may be able to distinguish among granulocytes, monocytes, and/or lymphocytes, or, in another embodiment, between at least two of T cells, B cells, macrophages, monocytes, neutrophils, eosinophils, basophils, and NK cells. In some embodiments, the system and method may be able to distinguish clinically relevant subtypes of WBCs, such as helper T cells, memory T cells, and/or cytotoxic T cells. In still other embodiments, the system and method may be able to distinguish clinically relevant phenotypes of a given WBC type, such as activated and non-activated phenotypes of cytotoxic T cells and/or NK cells.

Any WBCs that can be distinguished can be quantified and used to train the systems and methods of the present disclosure to provide diagnostic results based on WBC information. In some embodiments, these WBC-based diagnostic results may be integrated into the determination of whether a metastatic cancer is present. For instance, low levels of total WBCs, lymphocytes, T cells, NK cells, cytotoxic T cells, activated cytotoxic T cells, and/or activated NK cells may correlate with a higher likelihood of metastatic cancer because the body is not likely able to contain the primary tumor. In some such embodiments, a separate WBC-based diagnostic result may not be provided. In other embodiments WBC-based diagnostic results may be used to determine other diagnostic information relating to the cancer.

In some embodiments, the WBC-based diagnostic results may indicate whether the patient is like responding to, able to respond to, or in need of an immune regulation-based cancer therapy, such as PD-1/PDL-1 modulators or other checkpoint modulators. For instance, a patient with unusually (for example, as defined by clinical blood count guidelines) low total WBCs or a serious T cell deficiency may be considerably less likely to respond to an immune regulation-based cancer therapy, and may be treated with an alternative therapeutic method based upon the WBC-based diagnostic results. A patient who has been previously administered an immune-regulation based cancer therapy and exhibits unusually high levels of T cells, particularly cytotoxic T cells, may be responding well, and further treatment and diagnostic testing may be that suitable for patients responsive to the therapy. A patient who exhibits unusually high levels of T cells, particularly cytotoxic T cells, before being administered any cancer therapies may also be treated with immune regulation-based cancer therapies or referred for particular diagnostic testing based upon the WBC-based diagnostic results. In some instances, the patient may be a considered a good candidate for immune-regulation based cancer therapies that will bolster the existing immune response. In other instances, the patient’s immune response may be deemed sufficiently protective that other therapeutics methods, such as surgery, may be deemed sufficient, with no need for immune-regulation based cancer therapies.

In some embodiments, the system and method of this disclosure may detect information about WBCs in blood sample not detectable by conventional laboratory assays for WBCs, such as features of the WBCs that are only detectable via OCT. In these embodiments, the system and method may use diagnostically relevant information about WBCs that would not otherwise be available for use in diagnosis. In other embodiments, the system and method of this disclosure may detect information, such as cell counts, that may be available through other diagnostic assays. However, collection of this information contemporaneously with CTC analysis allows much quicker integration of the information to provide a metastatic cancer diagnosis and avoids the need for additional diagnostic tests to obtain WBC-based diagnostic results.

For any process or assay, the “sensitivity” of the process or assay is defined as the percent of processed or assayed items (such as cells or the sample as a whole) that are actually positive for a property that are also correctly identified as positive by the process or assay. For example, in the context of cell classification, cells are actually positive for a property if they would be identified as such by a cytologist. In the context of the assay as a whole, the sample is actually positive for malignant cells if such cells would be identified by a cytologist or are determined to be present by other methods or by progression of the cancer in a high number of patients who are identified as positive for malignant cells. Also, in the context of the assay as a whole, the sample is actually positive for a higher risk of metastatic breast cancer if a significant number of abnormal cells would be identified by a cytologist or if a high number of patients who are identified as positive for a higher risk of metastatic breast cancer progress to having such cancer.

Similar significance of sensitivity applies to other determinations that may be made using the blood cell classification method, such as whether the sample is positive for white blood cells, red blood cells, debris, or clusters.

For any process or assay the “specificity” of the process or assay is defined as the percent of processed or assayed items (such as cells or the sample as a whole) that are actually negative for a property that are also correctly identified as negative by the process or assay. Specificity may be determined in a manner similar to sensitivity, but based on absence of metastatic breast cancer or lack of progression to metastatic breast cancer in patients with negative results.

In the context of the categorization of blood cells or the overall assay, for each cell type, or for debris or clusters, the correct identification may be determined using a known identification method, such as microscope-based cytology (e.g. review or slides by a pathologist).

In embodiments in which 2D AI-based classification is implemented, sensitivity of 2D classification of cells as CTCs or other abnormal cells tends to be a more significant measure of accuracy than specificity because only cells that are CTCs or other abnormal cells are 3D imaged. A poor sensitivity for 2D AI-based classification can result in cells that have abnormal features not being 3D imaged and not included in the CTCs count, potentially resulting in false negatives with respect to either presence of malignant cells (and associated metastatic breast cancer), or higher than normal risk of metastatic breast cancer. In contrast, if specificity is poor, then more cells will be 3D imaged than is needed, unnecessarily slowing the blood cell classification somewhat, but not resulting in a significant number of CTCs or other abnormal cells being missed and false negatives produced.

In some embodiments, the pre-selected 2D AI-based classification sensitivity for CTCs or for other abnormal cells may be at least 90%, at least 95%, at least 98%, or in a range of 90% to 100%, 90% to 99.9%, 90% to 99%, 90% to 98%, 90% to 95%, 95% to 100%, 95% to 99.9%, 95% to 98%, 98% to 100%, 98% to 99.9%, or 98% to 99%.

In other embodiments, the pre-selected 2D AI-based classification specificity for CTCs or for other abnormal cells may be at least 65%, at least 70%, at least 75%, or in a range of 65% to 100%, 65% to 99%, 65% to 90%, 65% to 80%, 65% to 75%, 65% to 70%, 70% to 100%, 70% to 99%, 70% to 90%, 70% to 80%, 70% to 75%, 75% to 100%, 75% to 99%, 75% to 90%, or 75% to 80%.

The blood cell classification method 200 may also have a pre-selected 2D rejection rate. The 2D rejection rate is the proportion of the total number of enumerated analyzed cells that are identified as not having a property resulting in referral for 3D imaging. In some embodiments, the 2D rejection rate may be 99% or less, 98% or less, 95% or less, 90% or less, 85% or less, 80% or less, or 70% or less, in a range of 0%, 25%, or 50% to 70%, 80%, 85%, 90%, 95%, 98%, or 99%, or in a range of 70%, 80%, 85%, or 90% to 95%, 98%, or 99%. Acceptable 2D rejection rates may vary based on expected sample enrichment for CTCs or to remove RBC and platelets. Higher 2D rejection rates would be expected for less enriched samples.

Accuracy values may be calculated for AI-based 3D classification as well. Specifically, the 3D AI-based classification method may have a 3D CTC sensitivity that is the percent of cells that are or would be determined to have abnormal features using a known identification method, such as cytology (e.g. review by a pathologist), that are identified by AI-based 3D classification as such (or positive for malignant cells or for higher risk of metastatic breast cancer). When calculating the 3D CTC sensitivity, the number of false negative cells not referred for 3D imaging by the AI-based 2D classification must be subtracted from the known 3D CTC total cell count, as the 3D classifier did not have the opportunity to classify such cells as 3D CTC. A pre-selected minimum 3D CTC sensitivity helps avoid false negative test results. Similar calculations may be made for other accuracy parameters of AI-based 3D classification.

In some embodiments, the pre-selected 3D AI-based classification sensitivity for CTCs may be at least 75%, at least 80%, at least 85%, at least 90%, at least 95%, or in a range of 75% to 100%, 75% to 99%, 75% to 95%, 75% to 90%, 75% to 85%, 80% to 100%, 80% to 99%, 80% to 95%, 80% or 90%, 80% to 85%, 85% to 100%, 85% to 99%, 85% to 95%, 85% to 90%, 90% to 100%, 90% to 99%, 90% to 95%, 95% to 100%, or 95% to 99%. Similar sensitivities may be used for other object types, particularly those used for diagnostic purposes. In general, the AI-based classification sensitivity may be set so that, given the prevalence of the cell type in the sample, the product of sensitivity by prevalence yields the pre-selected number (e.g. four) of each type of normal cell.

In some embodiments, the pre-selected 3D AI-based classification specificity for CTCs may be at least at least 60%, at least 65%, at least 70%, or in a range of 60% to 100%, 60% to 90%, 60% to 80%, 60% to 70%, 65% to 100%, 65% to 90%, 65% to 80%, 65% to 70%, 70% to 100%, 70% to 90%, or 70% to 80%. Similar sensitivities may be used for other object types, particularly those used for diagnostic purposes. In general, the CTC AI-based classification specificity may be high, such that, for example, a epithelial cell or white blood cell is rarely identified as a CTC.

The blood cell classification method 200 also has pre-selected positive for malignant cell accuracy parameters for the method as a whole. The assay as a whole may also have pre-selected metastatic breast cancer or risk level accuracy parameters. The metastatic breast cancer sensitivity is the percent of patients who actually have metastatic breast cancer who are identified as having metastatic breast cancer by the blood cell detection method (a positive result). The risk level accuracy is the percent of patients who actually have that risk level based on cytological analysis of the sample.

The blood cell classification method 200 may also have a CTC sensitivity is the percent of cells that are or would be identified as CTCs using known identification methods that are identified as CTCs by the blood cell classification method 200. The assay CTC sensitivity may be approximated by multiplying the 2D CTC sensitivity by the 3D CTC sensitivity. The assay CTC specificity is the percent of cells that are or would be identified as not having abnormal features using known identification methods that are identified as not having abnormal features by the method 200. The assay CTC sensitivity may be approximated by multiplying the 2D CTC specificity by the 3D CTC specificity.

The assay as a whole may have sensitivity and specificity similar to those recited above for AI-based 3D classification.

In some embodiments in which the assay as a whole also provides another diagnostic determination, such as whether the is blood in the blood sample or whether the patient has an infection, the assay as a whole may have pre-selected accuracy parameters for these diagnostic determinations as well. Accuracy may be assessed against conventional methods or other ways of independently verifying the diagnostic status of the patient.

In step 300, the total cell count, and any applicable cell type, debris, or cluster counts are compared to pre-selected numbers to determine if the pre-selected number have been reached. If all pre-selected numbers have been reached, the method proceeds to step 310. If not, then method returns to step 250 to acquire images of additional cells.

In general, the accuracy of any blood cell classification method that uses 3D imaging of the type used in method 200 depends on the number of cells (particularly cells not formed via hematopoiesis) that are imaged. A pre-selected threshold number for a particular cell count maybe set to ensure a pre-selected level of accuracy. If this pre-selected threshold number cannot be met before the sample is exhausted, an error message may be generated.

In some embodiments, the pre-selected threshold number may simply be applied to the total cell count. In the embodiment described in FIG. 3, such a threshold is used. However, in many embodiments, the pre-selected threshold number may be of any cell type or combination of cells. In a specific embodiment, it may be a pre-selected threshold number of cells not formed via hematopoiesis. The pre-selected total cell count or total CTC count may, therefore, be at least 250, at least 400, at least 500, at least 600, at least 700, at least 800, at least 900, at least 1000, at least 1100, at least 1200, at least 1300, at least 1400, at least 1500, at least 2000, at least 2500, or in a range of 250 to 2500, 250 to 2000, 400 to 1900, 600 to 1800, 800 to 1700, 1000 to 1600, 1200 to 1600, or 1300 to 1500.

In some embodiments, more than one cell is located in a given volume of the optical medium, such that an additional cell may be identified, imaged, and used to update cell counts prior to the method proceeding to step 310 or returning to step 250.

In step 310, the CTC count is compared to at least one threshold number. If the number exceeds the threshold, then the blood sample is classified as positive for malignant cells, which means the patient has metastatic breast cancer. This comparison may be performed by processor 170.

In some embodiments, if the CTC count is below the threshold for positive for malignant cells, but still higher than an elevated risk threshold, then the blood sample is classified as from a patient at higher than normal risk for developing metastatic breast cancer.

In some embodiments, gradations of risk may also be implemented in the classification, using additional thresholds. For example, the patient may be classified as at high risk or at low risk for developing metastatic breast cancer.

In other embodiments, thresholds other than for CTCs may also be used to determine risk for developing metastatic breast cancer. For example, the patient may have a CTC count above a risk threshold, but below a positive for malignant cells threshold. Such a patient also have a cluster count above a positive for clusters threshold. This combined data from two different types of objects, CTCs and clusters, may indicate that the patient is actually at high risk for developing metastatic breast cancer.

The patient may also have other cell types compared to thresholds for other diagnostic purposes, such as infection, blood in blood, or presence or likelihood of a condition associated with debris in blood.

In some embodiments, cell classifications may be reviewed by cytologists who may use the 3D images of a cell 10.

Blood cell classifications may also include predicted accuracy data.

In some embodiments, patient data aids cell interpretation by the AI-based classification system. In this manner, data may include one or more of the following: patient age, patient gender, patient prior history with cancer, and patient prior history with non-cancer diseases.

In step 320, the blood cell classification results are provided to the user, for example using output 190, and may be stored, for example in memory 180.

Meyer, M.G., et al. (2015), The Cell-CT^{®} 3-dimensional cell imaging technology platform enables the detection of lung cancer using the noninvasive LuCED sputum test. Cancer Cytopathology, 123: 512-523 (doi.org/10.1002/cncy.21576); Wilbur, D.C., et al. (2015), Automated 3-dimensional morphologic analysis of sputum specimens for lung cancer detection: Performance characteristics support use in lung cancer screening. Cancer Cytopathology, 123: 548-556 (doi.org/10.1002/cncy.21565); US 6519355, US 6522775, US 6591003, US 6636623, US 6697508, US7197355, US 7494809, US 7569789, US 7738945, US 7811825, US 7835561, US 7867778, US 7787112, US 7907765, US 7933010, US 8090183, US 8155420, US 8947510, US 9594072, US10753857, US11069054, and US20200018704, are each incorporated by reference herein in its entirety and specifically as it relates to the components, basic operation, including image formation, including formation of pseudo-projection images, and 3D classifiers of optical tomography systems and cancer detection methods and systems described herein.

In some embodiments, when a blood sample is designated as positive for malignant cells, the patient may be referred for further metastatic breast cancer testing or they may begin treatment for metastatic breast cancer. When a blood sample is designated as having cells correlating with a higher than normal risk of metastatic breast cancer, the patient may be retested at set intervals or otherwise monitored or referred for further testing. When a blood sample is designated as not correlating with any increased risk of metastatic breast cancer, the patient may be monitored in the same manner as a normal, healthy adult.

In some embodiments, when a blood sample is designated positive for white blood cells, the infection may be treated.

In some embodiments, when a blood sample is designated positive for debris, the patient may be referred for further testing for a non-cancerous disease or disorder, or the positive result may confirm the presence of a non-cancerous disease or disorder for which the patient has other symptoms.

In embodiments where WBC-based diagnostic information is provided, similar steps may be performed to collect and analyze WBC information. In some such embodiments, a WBC cell type may be among the possible classifications in step 290, and step 310 may further include comparing the WBC cell type to a threshold along with comparing CTSs to a threshold and based upon both thresholds classifying the sample. In some embodiments, the threshold comparisons may be merged to result in a single classification, such as whether the patient likely does or does not have metastatic cancer. In other embodiments, a separate WBC-based classification that uses only the comparison of WBC cell type to a threshold may be made. In further embodiments, all classifications, or at least a cancer diagnostic-related classifications may be reported to the user in step 320.

### Training Methods

The present disclosure further includes a method of training AI-based components used in AI-based 2D or 3D cell classification. Classification in both 2D and 3D may be governed by a binary ground truth for the property of interest. For example, the cell may either have abnormal features or not have abnormal features. As another example, the cell may either be a CTC or not a CTC. As yet another example, the cell may be a non-cancerous circulating breast tissue-derived cell. As another example in which the AI-based system is allowed to determine parameters, the entire sample may be from a patient having metastatic breast cancer, or a patient not having metastatic breast cancer.

Trained AI-based classification systems and methods may be most accurate when implement on the same or a very similar type of optical tomography system as used in training. Cells for training purposes have a known type, or a patient has a known disease or risk state. During training, a process computes a plurality of cell features measurements for each of a plurality of known cells and identifies each cell in a binary fashion. The identification is compared to the known value. Accuracy of identification is assessed and, if it does not meet pre-set values, the processor adjust the algorithm using Adaptively Boosted Logistic Regression, Random Forest, Decision Trees, a convolutional neural network (CNN), or any combination thereof. Adaptively Boosted Logistic Regression uses logistic regression in an iterative loop to improve overall classification accuracy. This training process may be implemented on either the 2D or 3D AI-based classification method, or both.

If CTCs are identifiable as EpCAM+ or EpCAM-, similar methods may be used to train AI-base components used in AI-based 3D cell classification in particular to classify CTCs as EpCAM+ or EpCAM-. This information may be used in overall assessment of metastatic breast cancer risk or status for the patent, with EpCAM- CTCs being associated with EMT CTCs and a higher chance of metastasis.

Similar methods may be used to train AI-based components used in AI-based 2D or 3D cell classification to classify WBCs and/or to use WBC-based information in making a cancer-related classification of a sample, such as whether the patient likely does or does not have metastatic cancer.

FIG. 5 shows a system diagram that describes an example implementation of a computing system(s) for implementing embodiments described herein. The functionality described herein for a system for a method for providing equivalent services that can be implemented either on dedicated hardware, as a software instance running on dedicated hardware, or as a virtualized function instantiated on an appropriate platform, e.g., a cloud infrastructure. In some embodiments, such functionality may be completely software-based and designed as cloud-native, meaning that they are agnostic to the underlying cloud infrastructure, allowing higher deployment agility and flexibility.

In particular, shown is example host computer system(s) 601. For example, such computer system(s) 601 may represent those in various data centers and/or described herein that host the functions, components, microservices and other aspects described herein to implement a method for providing equivalent services to user devices across multiple participating telecommunication networks. In some embodiments, one or more special-purpose computing systems may be used to implement the functionality described herein. Accordingly, various embodiments described herein may be implemented in software, hardware, firmware, or in some combination thereof. Host computer system(s) 601 may include memory 602, one or more central processing units (CPUs) 614, I/O interfaces 618, other computer-readable media 620, and network connections 622.

Memory 602 may include one or more various types of non-volatile and/or volatile storage technologies. Examples of memory 602 may include, but are not limited to, flash memory, hard disk drives, optical drives, solid-state drives, various types of random-access memory (RAM), various types of read-only memory (ROM), other computer-readable storage media (also referred to as processor-readable storage media), or the like, or any combination thereof. Memory 602 may be utilized to store information, including computer-readable instructions that are utilized by CPU 614 to perform actions, including those of embodiments described herein.

Memory 602 may have stored thereon control module(s) 604. The control module(s) 604 may be configured to implement and/or perform some or all of the functions of the systems, components and modules described herein for a method for providing equivalent services to user devices across multiple participating telecommunication networks. Memory 602 may also store other programs and data 610, which may include rules, databases, application programming interfaces (APIs), software platforms, cloud computing service software, network management software, network orchestrator software, network functions (NF), AI or ML programs or models to perform the functionality described herein, user interfaces, operating systems, other network management functions, other NFs, and the like.

Network connections 622 are configured to communicate with other computing devices to facilitate the functionality described herein. In various embodiments, the network connections 622 include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 618 may include a video interface, other data input or output interfaces, or the like. Other computer-readable media 620 may include other types of stationary or removable computer-readable media, such as removable flash drives, external hard drives, or the like.

### EXAMPLES

A lung cancer detection method implemented using a CELL-CT^{®} optical tomography system has been developed that is able to detect lung cancer at a pre-invasive stage using AI-based classifications of cells. The lung cancer AI was trained using sputum samples from patients with lung cancer and normal patients. Although the morphology of abnormal cells associated with lung cancer and of abnormal cells associated with metastatic breast cancer is not identical, there are similarities. Accordingly, if a CELL-CT^{®} optical tomography system could be combined with AI-based classification of blood cells to detect metastatic breast cancer, such a system trained to detect lung cancer would be expected to also be able to detect metastatic breast cancer, although with less accuracy than a system trained using blood samples from patients with metastatic breast cancer and from normal patients.

### EXAMPLE 1

### Detection of CTCs in Blood

An AI-based OCT system with components as disclosed herein and implementing a method as disclosed herein that was trained to assess lung cancer based on the detection of abnormal bronchial epithelial cells was used to locate CTCs in whole blood in which RBCs were lysed, and to which BT474 breast cancer cells, a known metastatic breast cancer cell line, were added. Representative 2D sections of a 3D image of a breast cancer CTC detected using a Cell-CT system are provided in FIG. 5. These images show that breast cancer CTCs appear very different from WBCs in even the 2D images. Accordingly, methods in which 2D images are assessed to determine if the cell is likely a CTCs or not a CTC are expected to be able to effectively detect WBCs and eliminate these cells from 3D imaging, improving sample processing time and potentially also accuracy of CTC assessments.

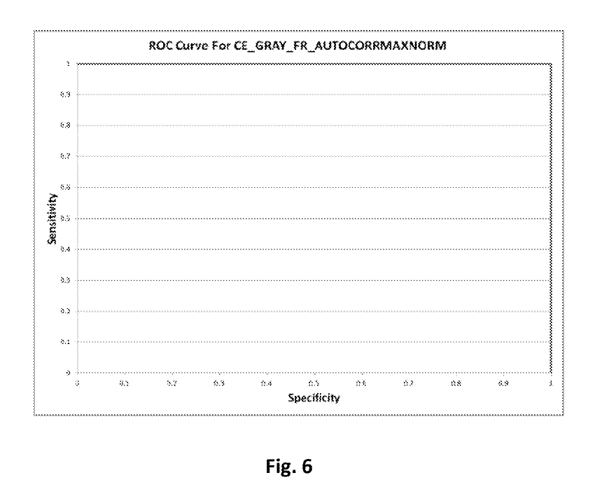

Even though not trained using CTCs, the AI-based OCT system was able to very accurately detect BT474 breast cancer cells in the lysed whole blood sample. An ROC chart for the assay is provided in FIG. 6 and is nearly perfect. Given that the number of BT474 cells added to the sample mimicked the expected prevalence of CTCs in blood samples from patients with metastatic breast cancer, it is expected that similar accuracy will be observed with such sample, particularly if a system and method using an AI component trained to detect CTCs in blood is used.

### Example 2

### Training Methods For Detection of CTCs in Blood

Training samples positive for CTCs may be whole blood from patients known to have metastatic breast cancer, whole blood from patients expected to be cancer-free to which known metastatic breast cancer cells (such as cells from standard cell lines or cells from patient biopsies or other tissue samples) have been added, whole blood from patients with non-metastatic breast cancer and/or other breast tissue abnormalities to which known metastatic breast cancer cells have been added, whole blood from patients with other types of cancer to which known metastatic breast cancer cells have been added, or any combinations thereof.

Training samples negative for CTCs may be whole blood from patients expected to be cancer-free, whole blood from patients with non-metastatic breast cancer, whole blood from patients with other breast tissue abnormalities, whole blood from patients with other types of cancer, or any combinations thereof.

If known metastatic breast cancer cells are added to whole blood, the cancer cells may be added at a set concentration, such as 100,000 cells per 10mL, 50,000 cells per 10mL, or 25,000 cells per 10 mL. In addition, the cancer cells may be treated, for example by trypsin, to reduce clumping or aggregation.

Whole blood samples may then be filtered, enriched for CTCs, then depleted to reduce processing time for assessing the sample for CTCs.

Whole blood samples may be suspended in optical medium prior to any labeling or enrichment, or in other medium sufficient to maintain intact cells.

Enriched cells may be suspended in optical medium, if not suspended in optical medium prior to enrichment.

Specimen preparation may be such that: i) cells are also stained in a manner that is compatible with identification by cytopathologists and fixed so that CTC-indicative morphology is preserved; ii) CTCs are present in a purity and concentration consistent with imaging approximately 1000 cells per sample/assay; iii) detection of CTCs in each sample using that AI-based systems and methods is 50% or higher.

For training or trained system/method evaluation, cells may be 3D imaged and classified, and 2D and/or 3D images may be further reviewed and classified by pathologists. In particular cells identified as CTCs may be reviewed by pathologists.

Classification data may exclude poorly detected cells to avoid erroneous results. Poor sample preparation may be detected by the presence of poorly detected cells above a set threshold. Poorly prepared samples may be rejected. Poor specimen adequacy may be detected if the total cell count, or cell count of a particular cell type does not exceed a set threshold. Inadequate samples may be rejected.

During training of the AI-based system, and, in some instances, during use of a trained system, three segmentation processes may be implemented:

Cell segmentation – 3D images are process to identify voxels that are associated with the cell.

Nuclear segmentation – The cell is sub-segmented to identify voxels associated with the nucleus.

Nucleoli segmentation – The cell nucleus is sub-segmented to identify voxels associated with the nucleoli.

Based on these segmentations, six sets of features may be computed: 1) features computed for background voxels, 2) features computed for the whole cell, 3) features computed for the nucleus, 4) features computed for the cytoplasm, 5) features computed for the nucleoli, and 6) relational features between cellular components, such as relationships between the nucleus and cytoplasm.

Not all sets of features may be used in all examples. In particular, trained AI-systems may rely on only some of these features, and features not relied upon may not be computed or determined as a result.

Features may describe object shape, intra-object voids, object location, and distribution of grey values within the object, among other properties.

Shape may be determined using simple volume, aspect ratio, and/or more complex measures involving rotation invariant computation based on principal component decomposition.

Intra-object voids may be computed for the shapes, sizes, and/or locations of voids within objects.

The location of objects may be determined by computing center of mass for objects. These allow relative assessment of nuclear to cytoplasm differentials, etc.

The distribution of grey scale features characterize, for example, the distribution of chromatin within the nucleus, or the character of the cell cytoplasm. Methods for grey scale computation include statistics computed based on gray scale histogram, Fourier-based assessments, run-length computations, and shape-normalized, rotation-invariant assessments.

At least 500 features may be computed for the cellular portion of each cell 3D image. Orientation-dependent features may be asses with respect to the principal axis that was computed for the cell, thus removing orientation-dependence as an influence on feature value.

AI-based systems may be trained using training data that employs a ground truth methodology. In this method, for each training cell, the system is provided with a binary indication of CTC or non-CTC, as determined by a pathologist, and a vector of features for the cell generated using the 3D image (or, for training initial processing using 2D classifiers, the 2D image). The CTC/non-CTC classification ground truth forms the basis for AI algorithm development and designates how the cell should be detected and classified if it were encountered in a sample being assayed using the trained AI-based system. The AI-based system seeks to replicate the ground truth identifiers set by pathologists using combinations of morphometric features.

In some embodiments, the AI-based system may undergo continual training to detect CTCs by providing additional individual cell data to the system and allowing the algorithm to undergo further optimization and training. This continual training may, in particular, be used to update the algorithm using data from cells the AI-based system mis-identified, as determined by pathologists. This data may be data residing on the individual system that is later flagged for use in AI-optimization, or it may be data provided from other, similar systems, used in different labs, allowing each AI-based system to benefit from information developed by other, similar systems. In addition, mis-identification data may be collected by a system administrator and used to train and updated AI-based algorithm that is then tested for accuracy, and provided to compatible systems.

Cells designated as CTCs may be reviewed by cytotechnologist and/or cytopathologists in combinations so that, for CTCs that are not from known cancer lines, designations are shared by at least two cytopathologists and/or cytotechnologists.

Final features selected in the training process and used by the trained AI-based system are selected during the AI-based system training process. Typically, these features will be a sub-set of available features. Any one or any combinations of feature selection processes may be used. Feature selection may, for instance, include forward selection using logistic regression, which results in rapid training, but at the expense of accuracy. Accordingly, a quick initial selection process may be followed by a more computationally expensive and slower method, such as the genetic algorithm, that improves accuracy. The number of features used in the final, trained algorithm for the AI-based system may be defined through cross-validation to ensure that the final algorithm generalizes across samples and/or similar systems.

Once the AI-based system in training has selected features, they are combined to form a single score that correlates with the CTC/non-CTC ground truth. Adaptive boosting (ada-boost) maybe used for this process. Ada-boost includes feature selection and incorporates feature selection into an iterative loop, which creates a more accurate AI-based algorithm from several less-accurate AI-based algorithms, each optimized to capture certain aspects of the data. The result is a score that ranges from 0 to 1. In an ideally trained AI-based algorithm, the score for a cell would be 1 when the ground truth is CTC, and 0 when the ground truth is non-CTC. In practice, the score tends to vary within the range for any given cell. Performance of the AI-based algorithm can be characterized through receiver operator characteristic (ROC) analysis. ROC plots sensitivity versus specificity to show the percent of cells correctly classified as non-CTCs.

The trade-off between sensitivity and specificity can be varied by applying thresholds of different values to the score. A measure of the composite performance of the AI-based algorithm may be expressed by computing the area under the ROC curve. Ideally this area would have a value of 1, but in practice will be less than one. Training can continue until the value of this area meets a set threshold reflecting a required accuracy.

The AI-based algorithm may also undergo cross-validation to address the danger of over-specialization. Iterative classification techniques, such as ada-boost, may become specialized to the sample noise in the training data, leading to overly-optimistic estimates of AI-based algorithm accuracy. To avoid this, cross-validation is used. For example, a 10-fold cross-validation may be employed. Cross-validation involves randomizing and sectioning the training data into parts (each part corresponding to a fold, so 10 parts for 10-fold cross-validation). One part of the data is reserved and the remaining parts are used to train the AI-based algorithm, which is then tested using the reserved part. This process is repeated x-fold number of times, which a different portion of the data being reserved each time, so that the total result encompasses the entire training set. Data is summarized by computing the area under the ROC curve for the training and test data for each set. As the AI-based algorithm accuracy improves, the area become closer to 1. An AI-based algorithm that provides no discrimination between the classes has an area of 0.5 on a straight line hypotenuse.

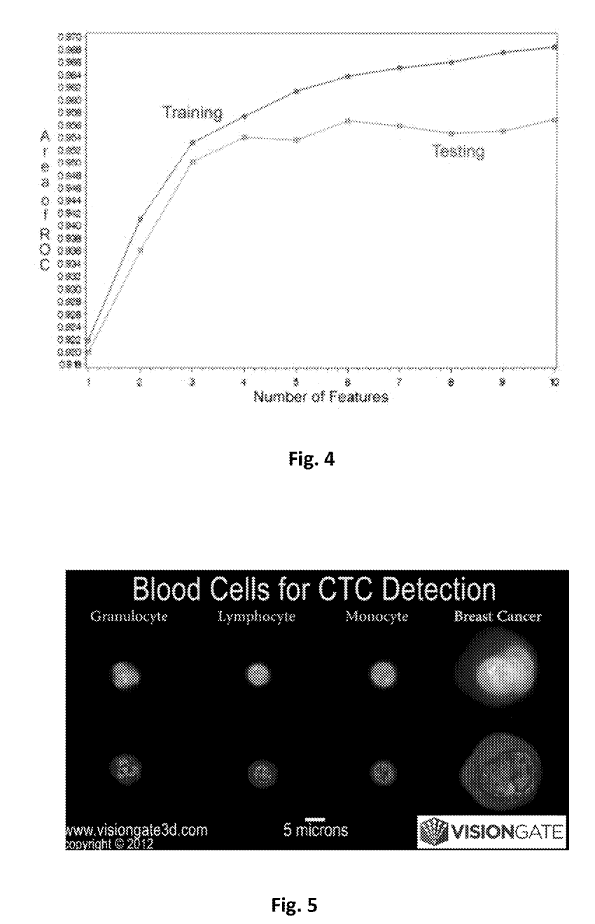

Training and testing values may be computed for two indices, i) the number of ada-boost iterations, and ii) the number of features involved per iteration. The result is a series of plots, one for each number of iterations. An example of what such a plot might look like is shown in FIG. 4. In this example plot, with increasing number of features, the area of ROC increases for training data, but levels of after four total features are used to evaluate the reserved, testing data. This graph, therefore, indicates that up to four features may be used per ada-boost iteration for this AI-based algorithm.

Once an appropriate training strategy has been identified and implemented, the training process may be repeated once again using the entire training data set.

### Example 3

### Clinical Verification Protocol

The ability of AI-based systems and methods as described herein to accurately detect and/or predict metastatic breast cancer may be evaluated by clinical verification using a protocol substantially similar to that provided in this Example.

Study Design – A prospective non-randomized longitudinal cohort study of breast cancer patients who are undergoing treatment for their cancer. The primary endpoint will be progression free survival (PFS) and/or absence of metastatic breast cancer.

Study Population – Patients with breast cancer who are planned to undergo treatment for their cancer. Treatment may be surgical, radiation therapy, and/or chemotherapy, including immune therapy.

Study Size – At least 8o patients, preferably 100, 150, or 200 patients.

Specimens – Peripheral venous blood samples from patients processed according to the protocol of Example 4 or another equivalent protocol involving lysis of RBCs and, optionally, filtering, enrichment for CTCs, and depletion to reduce processing time for assessing the sample for CTCs.

Number of measurements recorded per individual – i) Baseline (prior to any cancer treatment); ii) 1^{st} follow up (at least two weeks after first treatment) for a total of two CTC assays per individual.

Evaluation protocol – Results of CTC analysis will be withheld from physicians and clinicals who are making a determination of patient status (progression, progression-free, or metastasized). Such determinations of patient status will be based on laboratory and/or radiology exams according to PFS endpoint defined in FDA guidelines applicable at the time of the clinical trial.

Additional follow-up exams will occur periodically, such as monthly, to determine a date of progression of the cancer or of metastasis of cancer. No additional CTC measurements will be made in connection with these exams. Data collection will continue for nine months after the baseline sample has been collected for each patient.

Data analysis protocol – Kaplan-Meier plots will be generated for the baseline and follow-up groups based on whether the patients were determined to have CTCs present in the blood or not (e.g. CTC levels above or below a certain threshold), correlating with PFS or absence of metastatic breast cancer. Survival or non-metastasis curves will be compared using log-rank testing. Cox proportional hazards regression will be used to determine hazard rations for PFS or absence of metastatic breast cancer. Appropriate corrections based on the nine-month data cutoff will be applied.

Primary endpoints include determining the accuracy (including false positives and false negatives) of the AI-based system. Acceptable bias as compared to closest clinically comparable system (for detecting CTCs in blood and/or estimating metastatic breast cancer risk using whole blood) is -4 CTC cells.

Secondar endpoints include: i) determining the percent of specimens that meet the minimum number of cell criteria (specimen adequacy); ii) determining the percent of specimens that mees the staining quality requirements (sample prep); iii) determining the percent of specimens that meet threshold criteria for well-reconstructed cells/3D images (cell reconstruction quality).

### Example 4

### Blood Processing Protocol

Whole blood samples are collected from patients using peripheral venipuncture and stored, if necessary, without freezing in a manner sufficient to preserve healthy, intact cells, particularly CTCs. Blood samples may be refrigerated and stored for up to 24, 48, or 72 hours.

Whole blood samples may then be filtered, enriched for CTCs, then depleted to reduce processing time for assessing the sample for CTCs.

The whole blood sample may be centrifuged and the plasma fraction removed, leaving the red blood cell and white blood cell fractions. The retained fractions may then be re-suspended in a buffer. Red blood cells may then be lysed.

Cells are stained with hematoxylin, which is commonly used in cell-morphometric assessments, using typical protocols for such staining.

Cells are finally embedded into the optical medium for imaging.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise.

In the present description, any concentration range, percentage range, ratio range, or integer range is to be understood to include any values or subranges within the recited range unless otherwise indicated. It should also be noted that the term “or” is generally employed in its sense including “or” (i.e., to mean either one, both, or any combination thereof of the alternatives) unless the content dictates otherwise. Also, as used in this specification and the appended claims, the singular forms “a,” “an,” and “the” include plural referents unless the content dictates otherwise. The terms “include,” and “have” and their variants are used synonymously and are to be construed as non-limiting. The term “a combination thereof” as used herein refers to all possible combinations of the listed items preceding the term. For example, “A, B, C, or a combination thereof” is intended to refer to any one of: A, B, C, AB, AC, BC, or ABC. Similarly, the term “combinations thereof” as used herein refers to all possible combinations of the listed items preceding the term. For instance, “A, B, C, and combinations thereof” is intended to refer to all of: A, B, C, AB, AC, BC, and ABC.

1. An artificial intelligence (AI)-based circulating tumor cell (CTC) detection method using blood comprising:
a) generating, by an optical tomography system, a 2D image of a cell from a blood sample comprising a plurality of blood cells;
b) evaluating the 2D image using 2D AI-based classification to determine if the cell is an CTC;
c) generating, by the optical tomography system, a 3D image of the cell if the cell is determined to be an CTC; and
d) evaluating the 3D image using 3D AI-based classification to determine if the cell is an CTC, wherein a 3D image of the cell is not generated if the cell is determined by 2D AI-based classification to not be a CTC.

2. The method of claim 1, further comprising:
e) repeating a) to d) for a subset of cells within the plurality of cells to generate blood sample data that includes a total cell count reflecting the total number of cells evaluated using 2D AI-based classification and a CTC count reflecting the total number of cells determined to be an CTC by 3D AI-based classification.

3. The method of claim 2, further comprising:
f) comparing the total cell count to a cell count threshold number and repeating steps a) to e) if the total cell count is lower than the cell count threshold number.

4. The method of claim 2, wherein the cell count threshold number is sufficient to ensure a pre-selected accuracy of classification of CTCs, and wherein the threshold number is between 900 and 1100.

5. The method of claim 1, wherein the method has a pre-selected 2D AI-based classification sensitivity value for CTCs of at least 90%, and wherein the method has a pre-selected 3D AI-based classification sensitivity value for CTCs of at least 90%.

6. The method of claim 3, wherein the CTC count is compared to a CTC threshold and the sample is classified as from a patient with metastatic breast cancer if the CTC count is at or above the CTC threshold.

7. The method of claim 2, wherein the CTC count is compared to a first CTC threshold and a second CTC threshold and the sample is classified as from a patient with high risk of metastatic breast cancer if the CTC count is at or above the first CTC threshold and below the second CTC threshold, and further where the sample is classified as from a patient with metastatic breast cancer if the CTC count is at or above the second CTC threshold.

8. The method of claim 7, wherein the CTC count is a positivity rate calculated using a total number of CTCs classified compared to a total cell count.

9. The method of claim 1, wherein the blood sample comprises CTCs, epithelial cells, endothelial cells, white blood cells, debris, cell clusters, and any combinations thereof.

10. The method of claim 1, further comprising, prior to a), pre-processing the blood sample to stain the plurality of cells with an agent that facilitates generating the 2D image, evaluating the 2D image using 2D AI-based classification, generating the 3D image, or evaluating the 3D image using 3D AI-based classification.

11. The method of claim 1, further comprising, prior to a),
i) embedding the blood sample in an optical medium and injecting the optical medium with embedded sample into a capillary tube; and
ii) loading the capillary tube into the optical tomography system so that the capillary tube is between an illumination source and objective lens of the optical tomography system.

12. The method of claim 1, wherein generating, by the optical tomography system, the 2D image of the cell comprises the optical tomography system sweeping a focal plane of the optical tomography system in 1 µm steps across a single cell to generate a single-plane 2D image of the single cell at each step, compiling a plurality of single-plane 2D images of the single cell, and filtering the set of single-plane 2D images of the single cell to generate the representative 2D image of the cell evaluated in b).

13. The method of claim 12, wherein the representative 2D image of the cell is an image of a central portion of the cell.

14. The method of claim 1, wherein evaluating the 2D image using 2D AI-based classification comprises determining values for a plurality of 2D image cell feature measurements.

15. The method of claim 14, wherein the cell feature measurements comprise object shape features, cell-shape features, cytoplasm features, cell nucleoli features, distribution of chromatin, nuclear-size features, nuclear-texture features, other morphometric elements, or any combination thereof.

16. The method of claim 1, wherein evaluating the 3D image using 3D AI-based classification comprises determining values for a plurality of 3D image cell feature measurements.

17. The method of claim 16, wherein the cell feature measurements comprise object shape features, cell-shape features, cytoplasm features, cell nucleoli features, distribution of chromatin, nuclear-size features, nuclear-texture features, other morphometric elements, or any combination thereof.

18. The method of claim 1, further comprising determining if the cell is a white blood cell, a type or subtype of white blood cell, or a white blood cell having a specific phenotype.

19. A cell classification system comprising an optical tomography system operable to:
generate a 2D image of a cell from a blood sample comprising a plurality of blood cells;
evaluate the 2D image using 2D AI-based classification to determine if the cell is an CTC;
generate, a 3D image of the cell if the cell is determined to be a CTC; and
evaluate the 3D image using 3D AI-based classification to determine if the cell is a CTC.

20. A cell classification system comprising an optical tomography system operable to perform a method of claim 1.
